(19) United States
(12) Patent Application Publication
(10) Pub. No.: US 2012/0073435 A1
(43) Pub. Date: Mar. 29, 2012

(54) GAS SCRUBBING AND METHOD FOR OPERATION THEREOF

(75) Inventor: Andreas SELIGER, Munchen (DE)

(73) Assignee: LINDE AKTIENGESELLSCHAFT, Munchen (DE)

(21) Appl. No.: 13/241,987

(22) Filed: Sep. 23, 2011

(30) Foreign Application Priority Data
Sep. 23, 2010 (DE) 10 2010 046 334.5

(51) Int. Cl. B01D 53/14; F25J 3/08

(52) U.S. Cl. 95/24; 96/157; 62/617

(57) ABSTRACT

The invention relates to a gas scrubbing process, as well as a method for the operation thereof, in which during normal operation in an absorber column, gas components are separated from a gas mixture (feed gas) by scrubbing with a scrubbing liquid. The scrubbing liquid, loaded with separate gas components during the scrubbing process, is regenerated in a regeneration system that comprises at least one regeneration device equipped with a liquid level control. The regenerated scrubbing liquid is then recycled into the absorber column. When the feed gas is lost/reduced, the nominal value of the liquid level control is raised, and the resultant additional storage volume provided in the regeneration device is used for storing scrubbing liquid.

### SUMMARY OF THE INVENTION

The invention relates to a method for operating a gas scrubbing unit, in which, during normal operation, gas components are separated in an absorber column from a gas mixture (feed gas) by scrubbing with a scrubbing liquid (absorbent). In the scrubbing cycle, the scrubbing liquid, loaded with the absorbed gas components separated from the gas mixture, is regenerated in a regeneration system that comprises at least one regeneration device equipped with a liquid level control. Regenerated scrubbing liquid is then recycled again into the absorber column.

In addition, the invention relates to a device for implementing the method.

Gas scrubbing cycles of the generic type have been state of the art for many years and are used in a number of industrial applications for separating gas components from gas mixtures. The gas components that are separated from the gas mixture in the absorber column are removed from the loaded scrubbing liquid, by which the latter is regenerated. The regenerated scrubbing liquid is used again in the absorber column, while the scrubbed-out gas components are either removed or are directed to a productive use.

Crude synthesis gases are generated on an industrial scale from carbon and/or hydrocarbon feedstocks in gasification plants, for example, by reforming or by partial oxidation, and which—in addition to the desirable substances hydrogen and carbon monoxide—generally contain several undesirable components such as water, carbon dioxide (CO₂), hydrogen sulfide (H₂S) and carbon oxide sulfide (COS). For the purification of such crude synthesis gases, physical gas scrubbing cycles are preferably used. The latter are attractive since the crude synthesis gases are, in most cases, generated under high pressure, and in the first approximation, the effectiveness of physical gas scrubbing cycles increases linearly with the operating pressure.

The methanol scrubbing process, in which methanol is used as a scrubbing liquid, is of special importance for the purification of crude synthesis gases. It exploits the fact that the solubility coefficients of H₂S, COS and CO₂ in liquid, cryogenic methanol differ by several orders of magnitude from those of hydrogen and carbon monoxide. See, for example, U.S. Pat. No. 4,938,783.

In principle the inventive method can be employed in all physical and chemical scrubbing processes. Examples of suitable scrubbing processes include processes in which the scrubbing medium is ethanol, acetone, N-methylpyrrolydone, dimethylformamide, propylene carbonate, propylene glycol dialkyl ethers or mixtures thereof.

The amount of scrubbing liquid introduced into the absorber column primarily depends on the amount of the feed gas to be treated: the less feed gas is introduced into the absorber column, the less scrubbing liquid is required. Methanol scrubbing processes are typically designed in such a way that a reduction of the amount of crude synthesis gas that is used of up to 50% of the full load amount is easily possible. The amount of methanol run hourly in the circuit drops here to approximately 75% of the amount necessary at full load.

The smaller the liquid throughput in a column, the less liquid can be stored on the tray and/or in the packed bed sections of the column. Gas scrubbing processes therefore have column trays of sufficient size and/or separate buffer containers, in which the intermediate storage of scrubbing liquid can be ensured during a partial load operation.

To be able to ensure intermediate storage of the scrubbing liquid in a gas scrubbing process, even when the feed gas is lost, if the liquid content in the column trays or filler sections further decreases despite the amount of scrubbing liquid run in the circuit being maintained, it is necessary according to the state of the art to make the column trays and/or buffer containers even larger than is even necessary for conducting normal operations.

In particular, in a methanol scrubbing process, the investment costs thus increase considerably since, for example, the absorber column as a pressure container is manufactured from costly low-temperature steel and in general has to be designed with a great height per se even without a column tray.

Therefore, an object of this invention is to provide a method and a device of the above-described type by which the drawbacks of the prior art are overcome.

Upon further study of the specification and appended claims, other objects and advantages of the invention will become apparent.

On the method side, these objects are achieved according to the invention by a method which, when the flow of feed gas is reduced, provides for raising the nominal value of the liquid level control, and the additional storage volume thus provided in the regeneration device is used for storing scrubbing liquid.

A liquid level control has the object of keeping the liquid level constant within specified limits in a device with liquid intakes and discharges that fluctuate over time. The liquid level in this case fluctuates by the normal level NL (from the English Normal Level) specified as a nominal value between an upper boundary value HA (from the English High Alarm) and a lower boundary value LA (from the English Low Alarm).

During normal operation, liquid and gas simultaneously flow through devices used in the regeneration system of a gas scrubbing process, such as, for example, separators or heat-regeneration columns. To prevent liquid from being entrained by the gas flow and impairing the functionality of the device or even damaging the latter, the liquid level is kept far below the maximum possible liquid level HL (from the English High Level) using a liquid level control. The storage volume that is present in such a device can thus be used only incompletely during normal operation of the gas scrubbing process.

The invention makes use of the fact that when the feed gas is lost, no gas flows occur in the gas scrubbing process, even when the scrubbing liquid circuit is maintained. The liquid level in a regeneration device can therefore be set to a value of between NL and HL, without the regeneration device being damaged or else impaired only in its functionality.

Especially advantageously, the method according to the invention can be used in the operation of a methanol scrubbing process, in which carbon dioxide and other acid gases are separated from a gas mixture that contains hydrogen and carbon monoxide by means of cryogenic methanol that is used as a scrubbing liquid. By use of the method according to the invention, one can avoid the especially high costs associated with the extension of the tray space of the absorber column and/or the enlargement of the buffer container that is/are necessary according to the state of the art for the reasons explained in more detail above.

In addition, the invention relates to a device for separation of a gas mixture (feed gas) that comprises an absorber column in which the feed gas can be brought into contact with a scrubbing liquid, as well as a regeneration system with at least one regeneration device that is equipped with a liquid level control and in which the scrubbing liquid that is loaded with gas components in the absorber column can be regenerated.

On the device side, in accordance with the invention, the regeneration device has a storage volume that can be changed by adjusting the nominal value of the liquid level control.

The liquid level control is suitably designed in such a way that the liquid level in the regeneration device between LA and HL can be detected via the liquid level control, thereby making it possible to use the maximum storage volume in the regeneration device.

The regeneration systems of gas scrubbing processes often have separators for separating two-phase mixtures of substances. In their lower parts, these separators have a space for storing a liquid phase whose volume during normal operation can be used only to a certain extent during a loss of feed gas but which can be used in its entirety as a liquid reservoir. A preferred configuration of the device according to the invention therefore provides that the regeneration device is a separator in which loaded scrubbing liquid can be expanded and in which the two-phase mixture of substances that is produced in the expansion of the scrubbing liquid can be separated into a liquid phase and a gas phase.

An especially preferred configuration of the device according to the invention calls for its being designed as a methanol scrubbing process, in which carbon dioxide and other acid gases (e.g., H₂S, COS) can be separated from a gas mixture that contains hydrogen and carbon monoxide by means of cryogenic methanol that is used as a scrubbing liquid. Such methanol scrubbing process are frequently designed for a selective separation and recovery of carbon dioxide and the other acid gases, whereby a first methanol flow that is loaded only with carbon dioxide and a second methanol flow that is loaded both with carbon dioxide and other acid gases are generated. For recovery of hydrogen and carbon monoxide that are co-absorbed in the absorber column, the regeneration systems of such methanol scrubbing process comprise two separators that are designed with liquid level controls and in which the two loaded methanol flows are introduced independently of one another. In a suitable way, the nominal values of the two liquid level controls can be adjusted in such a way that the two separators can be used as a methanol reservoir in the case of a loss of feed gas.

The entire disclosure[s] of all applications, patents and publications, cited herein and of corresponding German Application No. DE 10 201 0 046 334.5, filed Sep. 23, 2010 are incorporated by reference herein.

The preceding examples can be repeated with similar success by substituting the generically or specifically described reactants and/or operating conditions of this invention for those used in the preceding examples.

1. A method scrubbing a gas mixture, comprising:
separating gas components from a feed gas mixture in an absorber column by scrubbing the feed gas mixture with a scrubbing liquid, whereby said scrubbing liquid becomes loaded with the separated gas components,
regenerating the loaded scrubbing liquid in a regeneration system comprising at least one regeneration device that is equipped with a liquid level control, and
recycling the regenerated scrubbing liquid to the absorber column,
wherein, the flow of feed gas is reduced, the nominal value of the liquid level control is raised, thus providing additional storage volume within said regeneration device, and said additional storage volume is used for storing scrubbing liquid.

2. The method according to claim 1, wherein the nominal value of the liquid level control is raised to a value of between the normal level (NL) and the maximum possible liquid level (HL).

3. The method according to claim 1, wherein said feed gas mixture that contains hydrogen and carbon monoxide, and carbon dioxide and/or other acid gases are separated from said feed gas mixture by means of cryogenic methanol that is used as a washing liquid.

4. The method according to claim 2, wherein said feed gas mixture that contains hydrogen and carbon monoxide, and carbon dioxide and/or other acid gases are separated from said feed gas mixture by means of cryogenic methanol that is used as a washing liquid.

5. An apparatus for separating gas components from a feed gas mixture, said apparatus comprising:
an absorber column, a first inlet for introducing a feed gas mixture, a second inlet for introducing a scrubbing liquid into said absorber column to contact the feed gas mixture, and
a regeneration system for regenerating scrubbing liquid loaded for the gas components to be separated from the feed gas mixture, said regeneration system having at least one regeneration device equipped with a liquid level control, wherein the storage volume of said regeneration device can be changed by adjusting the nominal value of the liquid level control.

6. The apparatus according to claim 5, wherein the liquid level in the regeneration device between the normal level (NL) and the maximum possible liquid level (HL) can be detected via the liquid level control.

7. The apparatus according to claim 5, wherein the regeneration device is a separator in which loaded scrubbing liquid can be expanded and in which two-phase mixtures of substances, produced in the expansion of scrubbing liquid, can be separated into a liquid phase and a gas phase.

8. The apparatus according to claim 6, wherein the regeneration device is a separator in which loaded scrubbing liquid can be expanded and in which two-phase mixtures of substances, produced in the expansion of scrubbing liquid, can be separated into a liquid phase and a gas phase.

9. The apparatus according to claim 5, wherein said apparatus is a methanol scrubbing system wherein said second inlet is in fluid communication with a source of cryogenic methanol as said scrubbing liquid, said second inlet is in fluid communication with a source of feed gas that contains hydrogen and carbon monoxide, and carbon dioxide and/or other acid gases are removed from said feed gas mixture by means of the cryogenic methanol scrubbing liquid.

10. The apparatus according to claim 6, wherein said apparatus is a methanol scrubbing system wherein said second inlet is in fluid communication with a source of cryogenic methanol as said scrubbing liquid, said second inlet is in fluid communication with a source of feed gas that contains hydrogen and carbon monoxide, and carbon dioxide and/or other acid gases are removed from said feed gas mixture by means of the cryogenic methanol scrubbing liquid.

11. The apparatus according to claim 7, wherein said apparatus is a methanol scrubbing system wherein said second inlet is in fluid communication with a source of cryogenic methanol as said scrubbing liquid, said second inlet is in fluid communication with a source of feed gas that contains hydrogen and carbon monoxide, and carbon dioxide and/or other acid gases are removed from said feed gas mixture by means of the cryogenic methanol scrubbing liquid.

12. The apparatus according to claim 8, wherein said apparatus is a methanol scrubbing system wherein said second inlet is in fluid communication with a source of cryogenic methanol as said scrubbing liquid, said second inlet is in fluid communication with a source of feed gas that contains hydrogen and carbon monoxide, and carbon dioxide and/or other acid gases are removed from said feed gas mixture by means of the cryogenic methanol scrubbing liquid.
